(19) United States
(12) Patent Application Publication
(10) Pub. No.: US 2003/0088852 A1
(43) Pub. Date: May 8, 2003

(54) Visual network operating system and methods

(75) Inventors: Mark A. Lacas, Seattle, WA (US); David J. Warman, Bainbridge, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lone Wolf Technologies Corporation.

(21) Appl. No.: 10/008,541

(22) Filed: Nov. 7, 2001

(51) Int. Cl. G06F 9/44

(52) U.S. Cl. 717/121

(57) ABSTRACT

This invention generally relates to a visual network operating system (“VNOS”) for graphically interacting with devices and/or applications associated with a computing device. Specifically, a graphical control system for creating and operating decomposable visual components (“DVCs”) in a VNOS. The DVCs may be related to system elements such as devices, and software programs that may be controlled by, observed by and/or manipulated by the DVCs. In accordance with one aspect of other present invention, a method is provided for creating DVCs in the VNOS, including providing a library of objects which may then be used to instantiate DVCs from the library. Once instantiated these DVCs may then be configured while their operation is displayed in a user interface. Specifically multiple DVCs may be instantiated and connected such that a value in one DVC is communicated to another DVC.

### FIELD OF THE INVENTION

This invention generally relates to a method and apparatus for using a computing device to control other devices and/or applications in communication with the computing device and more specifically to a visual network operating system for graphically interacting with devices and/or applications associated with a computing device.

### BACKGROUND OF THE INVENTION

Object-oriented programming paradigms have become an increasingly common tool in computer programming. Such paradigms often employ graphical user interfaces, where computer system elements are visually represented and manipulated by visible screen entities such as icons on a computer screen or other display device. For programming purposes, “objects” are used to represent the manipulatable computer system elements by containing methods and data that define those elements. Representing computer system elements as objects makes it unnecessary for a programmer to generate a specific set of code for each computer system element. Rather, the programmer can define classes of objects and assign certain universal behaviors to each class. Computer system elements that can be represented by objects include computer peripherals, other computers, non-computing devices, and computer application programs. Examples of application programs are spreadsheets, word processing programs, database programs, graphics programs, etc.

In graphical user interfaces employed in object-oriented programming paradigm, application programs are typically represented to a user by an icon displayed within a window on a computer screen, one icon for each application program that can be run. Execution of an application program is initiated by selecting its corresponding icon, most often using a pointing device such as a mouse. When an application program is selected, a message is sent to the corresponding application program object, indicating that the application program object is to invoke certain of its methods. For example, if a word processing program is selected, the methods contained within the application program object may include starting the word processing program. The user may also “drag” icons from one area of the screen to another, or from one window to another using a graphical user interface control device, such as a mouse. The user may even drag one icon representative of an application object and “drop” that icon on top of another. This “object-object” interaction will result in a combination of application objects. For example, if a word processing document icon is dropped upon a word processing program icon, the object-object interaction results in starting the word processing program and causing that program to open the word processing document. This is possible because both the word processing program and the word processing document have been represented as compatible application program objects. Hence, the icons in the object-oriented programming paradigm allow the user to graphically control various computer system elements and the interrelationships between computer system elements.

While the conventional object-oriented, graphical user interface described above has been used to allow a user to initiate execution of such computer system elements as applications programs, use of object-oriented programming paradigms to graphically control and monitor computer system elements has been severely limited.

In particular there have been no object-oriented tools for developing visually built “programs” that allow the builder/programmer to view the operation of both the program and the computing device components and/or applications built into the program.

Accordingly, there is a need for a graphical control system for controlling system elements and the relationships between those elements. In order to eliminate the need for specially designed code for each system element, such a graphical control system should employ a common paradigm for representing the system elements to be controlled. In addition, the graphical control system should provide for dynamic visual element controls that represent each feature control of an element and allow a user to graphically control and monitor each system element without having any specific knowledge about the element and without making any physical contact with the element. The present invention is directed to providing such a graphical control system.

### SUMMARY OF THE INVENTION

In accordance with this invention, a graphical control system for creating and operating decomposable visual components (“DVCs”) in a visual networking operating system (“VNOS”) is provided. The DVCs may be related to system elements such as computing devices, noncomputing devices and software applications or programs that may be controlled by, observed by and/or manipulated by the DVCs. In accordance with one aspect of other present invention, a method is provided for creating decomposable visual components in the visual networking operating system including providing a library of visual component templates or objects which may then be used to instantiate decomposable visual components from the library. Once instantiated these decomposable visual components may then be configured while their operation is displayed in a user interface. Specifically multiple DVCs may be instantiated and connected such that a value in one DVC is communicated to another DVC.

In another aspect of this invention, a control DVC that is depicted so as to enable a user to modify the control DVC in such a way as to communicate that modification to one or more target DVCs within the VNOS system such that the target DVC(s) detects the modification in the first DVC and then effectuates a change in the one or more target DVC(s) is provided.

As can be readily appreciated from the foregoing summary, the invention provides a graphical control system for creating and manipulating components representing system elements and the relationships between those elements. Additionally, the graphical control system of the present invention eliminates the need for custom coding when communicating or observing changes in a system element. Still further, it will be appreciated that by using a graphical control system, an efficient object-oriented paradigm may be used to build more complex visual components for use in still further embodiments of the present invention.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 (prior art) is an illustration of a representative portion of a VNOS network such as the Internet.

FIG. 2 is a pictorial diagram of a number of devices connected to a VNOS network which provide a UI device with the necessary connections to build a VNOS application in accordance with the present invention.

FIG. 3 is a block diagram illustrating several components of the UI device shown in FIG. 2 used to build and operate VNOS applications in accordance with the present invention.

FIG. 4 is a block diagram illustrating several of the components of a Vaemon device shown in FIG. 2 used to augment the capabilities of UI devices in accordance with the present invention.

FIG. 5 is a flow chart illustrating the communications provided by the VNOS system shown in FIG. 2.

FIG. 6A is a class hierarchy and instance diagram illustrating exemplary classes of objects in accordance with the present invention.

FIG. 6B is an illustration of an exemplary VU meter object in accordance with the present invention.

FIG. 7 is an overview flow diagram illustrating a decomposable visual component creation process in accordance with the present invention.

FIG. 8 is an overview flow diagram illustrating a decomposable visual component configuration subprocess in accordance with the present invention.

FIG. 9 shows an exemplary decomposable visual component and its inherent properties in accordance with the present invention.

FIGS. 10A-10E show exemplary windows illustrating the creation of a complex decomposable visual component in accordance with the present invention.

FIG. 11 illustrates the flow of messages between instances of objects within the VNOS system shown in FIG. 2 enabling a user to represent and manipulate values of a system element in accordance with the present invention.

### DETAILED DESCRIPTION OF THE PREFERRED EMBODIMENT

As will be better understood from the following description, the present invention is directed to a graphical control system for controlling system elements, wherein virtually any controllable element can be controlled. The invention employs a personal computer, a network, interfaces for connecting the computer and the system elements to the network, and a VNOS. While the one exemplary network is a wired network, such as a fiber optic network or the Internet, other types of networks including wireless networks, can be employed in embodiments of the invention. Further, the network can simply be a point-to-point connection for connecting a computer to the interface of a single system element. The VNOS that controls the operation of the computer, is based on an object-oriented programming paradigm and communication networks. In order to better understand the preferred embodiment of the invention described below, certain aspects of communication networks and object-oriented programming paradigms that are relevant to the following discussion are first described.

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”) consisting of a few computers or workstations and related devices; to a wide area network (“WAN”) which interconnects computers and LANs that are geographically dispersed; to a remote access service (“RAS”) which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”) along with higher level protocols such as the Transmission Control Protocol/Internet Protocol (“TCP/IP”) or the Uniform Datagram Packet/Internet Protocol (“UDP/IP”) to communicate with one another.

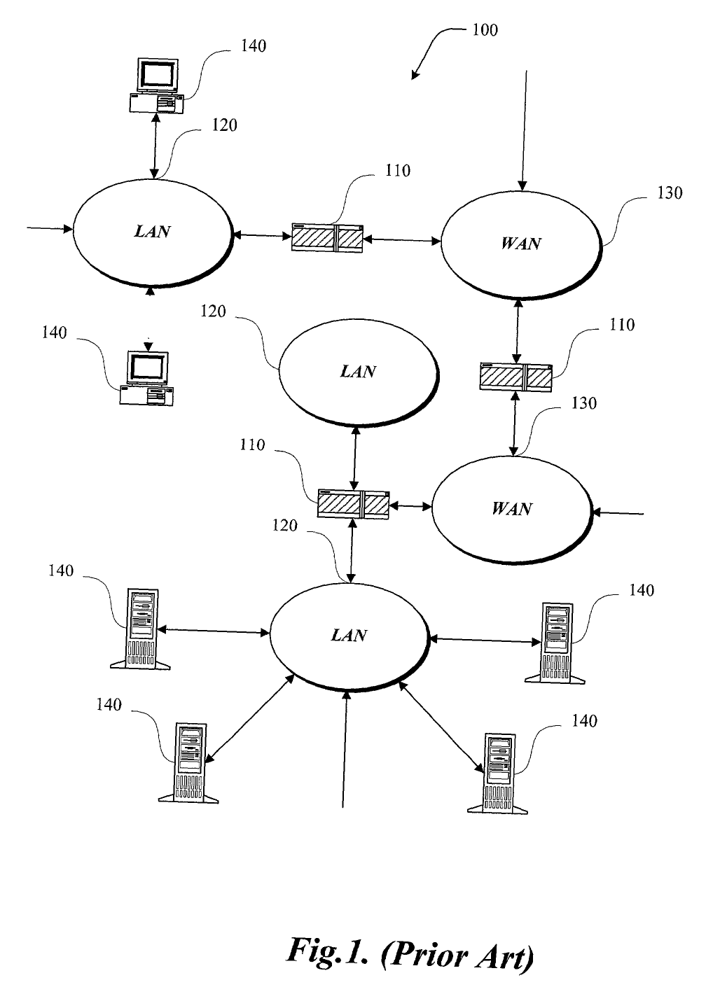

A representative section of the VNOS network 100 (such as the Internet) is shown in FIG. 1 (Prior Art) in which a plurality of LANs 120 and WANs 130 are interconnected by routers 110. The routers 110 are generally special purpose computers used to interface one LAN or WAN to another. Communication links within the LANs may be twisted pair wire, coaxial cable, or wireless networking signals, while communication links between networks may utilize 56 Kbps analog telephone lines, or 1 Mbps digital T-1 lines, 45 Mbps T-3 lines, and/or other high-speed network links. Further, computers and other related electronic devices can be remotely connected to either the LANs 120 or the WAN 130 via a modem and temporary telephone link. Such computers and electronic devices 140 are shown in FIG. 1 as connected to one of the LANs 120 via dotted lines between arrows. It will be appreciated that the Internet comprises a vast number of such interconnected networks, computers and routers and that only a small, representative section of the Internet, which in one embodiment of the present application may be used to form the VNOS network 100, is shown in FIG. 1.

The fundamental aspects of object-oriented programming paradigms are that objects can be organized into classes in a hierarchical fashion and that objects are interoperable. Classes are abstract generic descriptions (templates) of objects and their behaviors. A class defines a certain category or grouping of methods and data within an object. Methods comprise procedures or code that operate upon data. Methods as applied to data define the behavior of the object. Refinement of the methods of the class is achieved by the creation of “sub-classes.” In other words, a class can be thought of as a genus, and its subclass as the species. Subclasses allow the introduction of a new class into the class hierarchy and inherit the behaviors of its superclass while adding new behaviors to the subclass.

An instance of a class is a specific individual entity, something concrete having observable behavior. An instance is a specific object with the behaviors defined by its class. Instances are created and deleted dynamically in an object-oriented programming paradigm. The class, however, is the broad, yet abstract, concept under which the instance belongs. The instance inherits all the methods of its class, but has particular individual values associated with it that are unique. There is only one class of a particular type within a VNOS. There may, however, be numerous instances of the class, each of which has different values and different physical locations in memory.

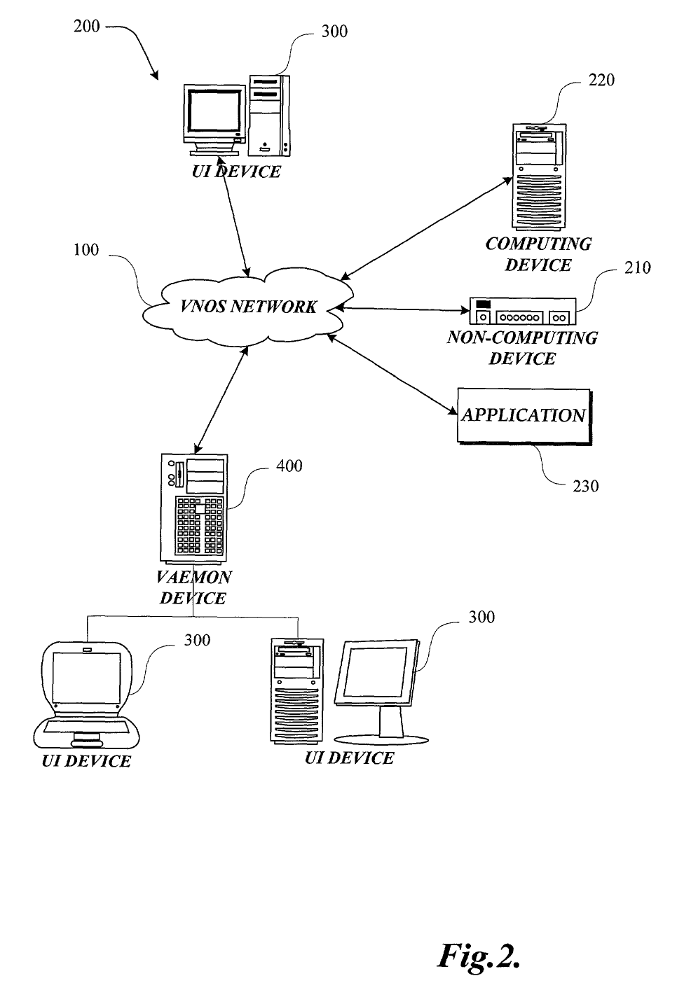

FIG. 2 illustrates a VNOS system 200 having a network 100 interconnecting a number of user interface (“UI”) devices 300, one or more visual daemon (“Vaemon”) devices 400 and a plurality of system elements 210, 220, 230. The graphical control system of the present invention employing the object-oriented programming paradigm as described above allows a user to use a UI device 300, or a UI device in communication with a Vaemon device 400, to control the operation of the system elements 210, 220, 230 via the VNOS network 100. For ease of illustration only three system elements 210, 220, 230 are shown in FIG. 2. The illustrated system elements are a non-computing device 210, a computing device 220, and a software application 230. As will be appreciated by those of ordinary skill in the art from the following description, additional system elements can be connected to and controlled by UI device 300 via the VNOS network 100. System elements may include printers, monitors, video cameras, speakers, television sets, telephones, lamps, software components, etc. Even simple light switches can form system elements.

In addition, those of ordinary skill in the art will recognize that additional UI devices 300 and Vaemon devices 400 may be connected to VNOS network 100 and simultaneously used to control system elements. In fact, any computer system including but not limited to portable computers, PowerBooks, personal device assistants and the like, that is equipped to be connected to VNOS network 100 or any other coupling medium may be used to control the system elements.

Various network communication protocols can be used to communicate over the VNOS network 100. In one actual embodiment of the present invention, the network communication protocol used to communicate over the VNOS network 100 is of the type disclosed in commonly assigned U.S. Pat. Nos. 5,245,604 and 5,657,221, entitled “Communication System,” and “Method and Apparatus for Controlling Non-computing System Devices By Manipulating a Graphical Representation,” respectively, the disclosures and drawings of which are specifically incorporated herein by reference. The network communication protocol described by U.S. Pat. Nos. 5,245,604 and 5,657,221 is referred to herein as the MediaLink protocol. The advantage of the MediaLink protocol is that it provides an upper limit on the amount of time it takes to communicate over the VNOS network 100. This is important in real-time environments such as a musical performance stage, where unpredictable delay would result in unacceptable performance of the system elements. As all network communication protocols must, the MediaLink protocol includes a network resource sharing and management algorithm such that only one UI device 300 communicates over the VNOS network 100 at any one given time and such that each UI device 300 has sufficient access to the VNOS network 100. While the MediaLink protocol and the VNOS network 100 are described, it is to be understood that other network protocols and networks other than the type shown in FIGS. 1, 2 and 7 may be used in actual embodiments of the invention. In particular, the VNOS system 200 of the present invention does not require VNOS hardware interfaces with system elements 210, 220, 230. Still additional communications protocols may be used, in particular, in one actual embodiment a DVC-to-DVC protocol is used to enhance the integration and communication between DVCs. Additionally protocols may be used to incorporate Vaemon devices 400 into the VNOS system 200 so as to provide additional processing and increased capabilities in conjunction with UI devices 300.

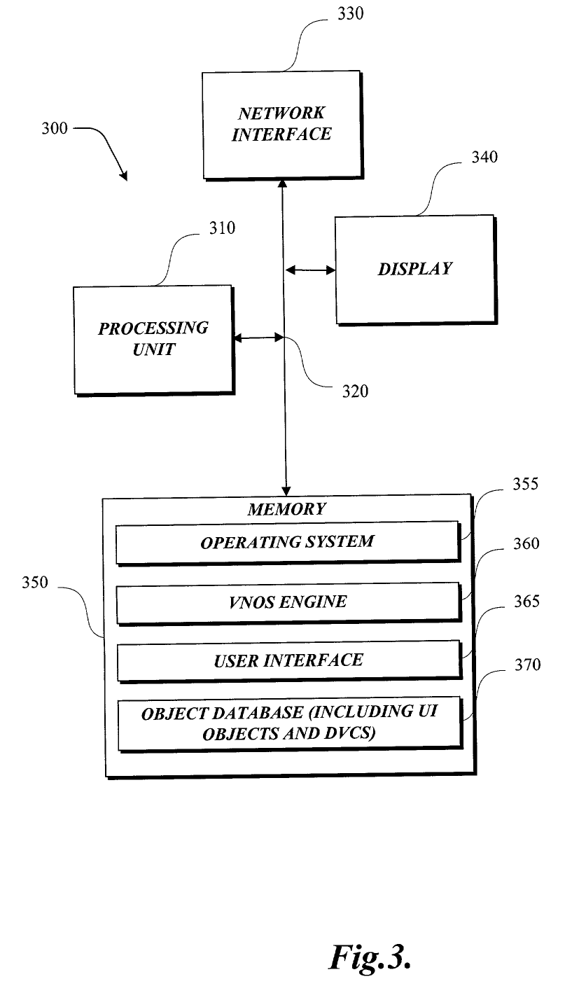

FIG. 3 depicts several of the key components of the UI device 300. Those of ordinary skill in the art will appreciate that the UI device 300 may include many more components than those shown in FIG. 3. However, it is not necessary that all of these generally conventional components be shown in order to disclose an enabling embodiment for practicing the present invention. As shown in FIG. 3, the UI device 300 includes a network interface 330 for connecting to the VNOS network 100. Those of ordinary skill in the art will appreciate that the network interface 330 includes the necessary circuitry for such a connection, and is also constructed for use with the MediaLink protocol, the TCP/IP protocol, or other protocols such as the Internet Inter-ORB Protocol (“IIOP”).

The UI device 300 also includes a processing unit 310, a display 340, and a memory 350 all interconnected along with the network interface 330 via a bus 320. The memory 350 includes any necessary temporary and permanent storage devices, including but not limited to random access memory (“RAM”), a read-only memory (“ROM”), and a permanent mass storage device, such as a disk drive. The memory 350 stores an operating system 355, a VNOS engine 360, a UI 365 to the VNOS engine 360, and an objects database 370 (including a library of objects specific to the UI 365 as well as objects representing decomposable visual components used by the VNOS engine 360). The VNOS engine 360 provides the enhanced object oriented processing control utilized by the DVCs of the present invention. It will be appreciated that these software components may be loaded from a computer-readable medium into memory 350 of the client device 300 using a drive mechanism (not shown) associated with the computer-readable medium, such as a floppy, tape or DVD/CD-ROM drive or via the network interface 330.

Although an exemplary UI device 300 has been described that generally conforms to a conventional general purpose computing device, those of ordinary skill in the art will appreciate that a UI device 300 may be any of a great number of devices capable of communicating with the VNOS network 100 system elements 210, 220, 230, or with a Vaemon device 400.

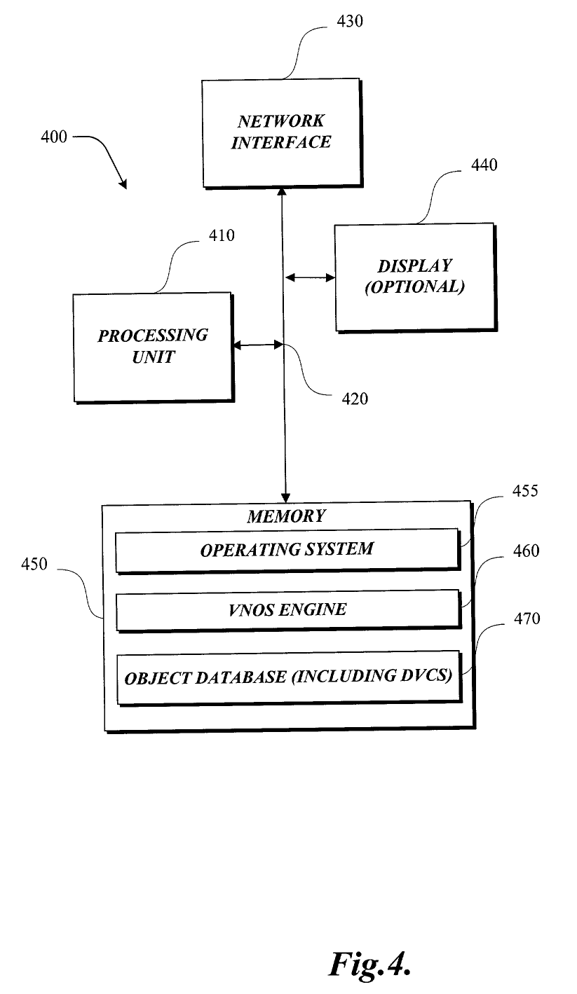

FIG. 4 depicts several of the key components of the Vaemon device 400. Those of ordinary skill in the art will appreciate that the Vaemon device 400 includes many more components then those shown in FIG. 4. However, it is not necessary that all of these generally conventional components be shown in order to disclose an enabling embodiment for practicing the present invention. As shown in FIG. 4, the Vaemon device 400 is connected to the VNOS network 100 via a network interface 430. Those of ordinary skill in the art will appreciate that the network interface 430 includes the necessary circuitry for connecting the Vaemon device 400 to the VNOS network 100, and is also constructed for use with the MediaLink protocol, the TCP/IP protocol or other protocols, such as the IIOP.

The Vaemon device 400 also includes a processing unit 410, an optional display 440, and a mass memory 450 all interconnected along with the network interface 430 via a bus 420. The memory 450 includes any necessary temporary and permanent storage devices such as RAM, ROM, and one or more permanent mass storage devices, such as a hard disk drive, tape drive, optical drive, floppy disk drive, or combination thereof. The memory 450 stores an operating system 455, a VNOS engine 460, and an object database 470.

It will be appreciated that the aforementioned software components may be loaded from a computer-readable medium into mass memory 450 of the Vaemon device 400 using a drive mechanism (not shown) associated with the computer-readable medium, such as floppy, tape or DVD/CD-ROM drive or via the network interface 430.

Although an exemplary Vaemon device 400 has been described that generally conforms to a conventional general purpose computing device, those of ordinary skill in the art will appreciate that a Vaemon device 400 may be any of a great number of devices capable of communicating via the VNOS network 100, or communicating with one or more UI devices 300.

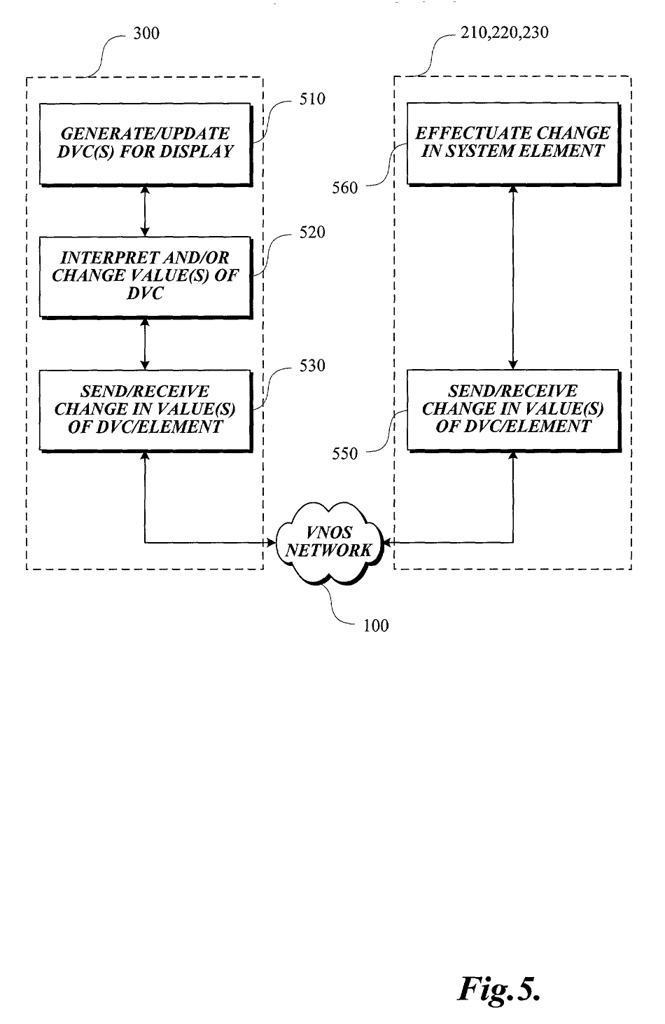

FIG. 5 is a flow chart illustrating the control and monitoring functions performed by the VNOS system 200 of the present invention and the order in which these functions are performed. As noted above, VNOS system 200 uses a distributed operating system that is stored in the UI device(s) 300 and may also be stored in the Vaemon device(s) 400. The displayed portion is stored in the UI device 300. Blocks 510, 520, 530 represent the functions of VNOS that control the operation of the UI device 300, and blocks 550 and 560 represent the functions of VNOS system that control the operation of a system element 210, 220, or 230.

Beginning at block 510, the VNOS engine 360 generates a graphical control display upon the screen 340 of a UI device 300 that contains a number of DVCs. As previously described, each visual DVC graphically represents a corresponding control or display of one of the system elements 210, 220, 230 to be controlled (FIG. 2) or is a component of the VNOS engine 360. In addition to displaying graphics, each DVC represents at least one value and may have default input and output values. Whenever the user manipulates a DVC using a control device (e.g., a mouse, stylus, keyboard, etc.) in the appropriate manner, a change in the associated value results. Hence, in block 520, the VNOS engine 360 interprets the value, which is then stored in the RAM 350 of the UI device 300. In some embodiments of the invention, the VNOS engine 360 may further manipulate and change the value before storing them. At block 530, the VNOS engine 360 communicates the change in the value associated with the DVC to the related system element 210, 220, 230 via the VNOS network 100.

Proceeding to block 550, the system element 210, 220, 230 receives the change in value associated with the feature control or display. Then, at block 560, the corresponding control or display is adjusted in accordance with the received change in value.

While VNOS system 200 of the graphical operating environment of the present invention is designed, in part, for use in the forward direction beginning at block 510 and preceding to block 560, in some embodiments of the invention it may be desirable for the system element 210, 220, 230 to be operated by another source located on the system element 210, 220, 230 or by another computer. In addition, a control or display may be automatically and electrically adjusted by a command generated internally, as is the case with meters and temperature gauges that monitor constantly fluctuating values. In such cases, the order in which the VNOS functions are performed in FIG. 5 is reversed so that communication begins at block 560 and proceeds to block 510. In this case, a change in value resulting from an adjustment of a control or display at the system element 210, 220, 230 is sent from the element to the other element and to the UI device 300. As a result, the DVC representing the control or display on the screen 340 of the UI device 300 is regenerated in accordance with the change in value.

In order to accomplish the functions generally depicted in FIG. 5 and described above, the VNOS system 200 uses an object-oriented programming paradigm to represent system elements 210, 220, 230. One fundamental aspect of object-oriented programming paradigms is that objects can be organized into classes in a hierarchical fashion. Classes are abstract generic descriptions of objects and their behaviors. A class defines a certain category or grouping of methods and data within an object. Methods provide the “intelligence” of a class and comprise procedures or codes that operate upon the data. Methods as applied to data define the behavior of an object. This concentration of intelligence in the methods of object classes is essential in object-oriented systems. It permits large-scale maintenance efforts, since the methods or intelligence of objects is inherited from their class. So, effecting a change once in the methods of a class will automatically effect changes in the methods of all the objects of that class and its subclasses. Additional information on object oriented programming can be found in “Object-Oriented Modeling and Design,” by Rumbaugh et al., published by Prentice Hall in 1991, of which the text and drawings are specifically incorporated by reference.

In an object-oriented programming paradigm, objects are categorized into classes, where a class defines a category of methods and data within its objects. Methods as applied to data define the behavior of an object. An instance is a specific object with the behaviors defined by its class.

Another fundamental aspect of object-oriented programming is that objects are interoperable. In this regard, the classes that define DVCs contain generic methods, and class-specific methods that interact with the data totally surround the data and, as is described in the art, encapsulate the data. Only the methods of objects are allowed to know anything about the private data of the objects. The methods isolate the encapsulated data from other parts of the system making the object interoperable with other objects regardless of the data contained by those objects. The user is capable of modifying the system as new elements appear or disappear on the network, by merely changing the data, since an object is interoperable and need only be concerned about how it represents the data for which it is responsible.

Yet another fundamental aspect of object-oriented programming is that objects are composable, i.e., the methods surrounding the data may be predefined and subsequently modified. Generic methods are methods present in all objects of a class. Exemplary generic methods may translate data in an object to a textual representation, so as to ease storage or retrieval from a file or other computer readable medium. Such generic methods may be employed when the user requests a full state save or restoration of all objects upon shut-down or power-up of the personal computer. These generic methods are also referred to as “interpret and describe” methods. Other exemplary generic methods may provide for communication between objects including methods for generating pointers to other objects and methods for sending messages to other objects.

As opposed to generic methods, class-specific methods are unique for a particular class. The class-specific methods usually provide the logic that implements special behaviors of the object that are unique to the particular class of object.

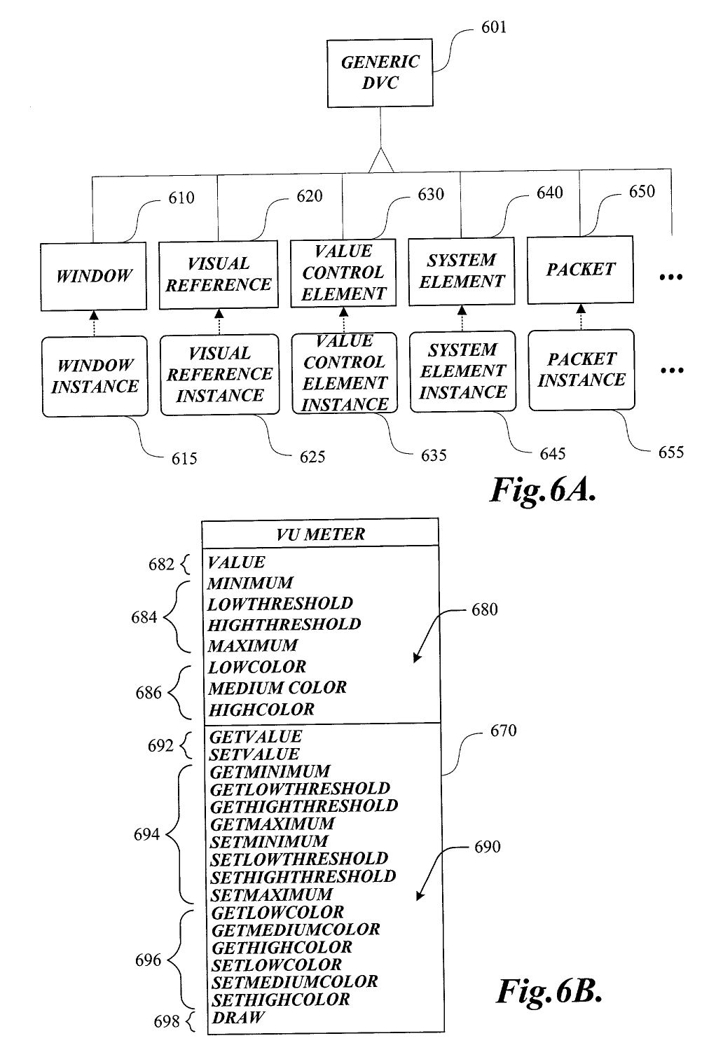

The object-oriented programming paradigm employed by the current invention can be used to create a vast number of objects. Five different exemplary objects that are used by DVCs—a window object 610, a visual reference object 620, a value control element (“VCE”) object 630, a system element object 640, and a packet object 650—are illustrated in FIG. 6A and described below to aid in understanding the present invention. Each object is shown as a class beneath the class “object” 601. Briefly, window objects 610 contain the data and methods necessary for displaying a window on a computer display 340; visual reference objects 620 contain the methods and data necessary for generating visual representation of a DVC 40 on a window object; VCE objects 630 contain the value represented by a DVC and the methods for manipulating that value; system element objects 640 contain the methods and data for communicating with a particular type of system element 210, 220, 230 and for managing a graphical control display of that system element 210, 220, 230; and packet objects 650 contain the methods and data for communicating data between a system element and the UI device 300 via the VNOS network 100. By combining these objects, it is possible to compose simple or highly complex DVCs. It is also possible to create intermediately complex DVCs and store them as objects that may in turn be used to create more complex DVCs.

As will be readily apparent to one of ordinary skill in the object-oriented programming art, the window, visual reference, VCE, system element and packet objects (which are shown as classes in FIG. 6A) may be subdivided into further subclasses. For example, system element object 640 may be divided into subclasses of desktop computers, laptops, amplifiers, equalizers, CD players, software applications, etc. Each of these subclasses may then be subdivided again. For example, the subclass of laptop computers may be divided into subclasses of laptop computers wherein each subclass comprises laptop computers produced by a particular manufacturer.

The VCE object 630 serves to interpret, store and perhaps further manipulate the information held in a DVC. The data of a VCE object 630 comprises the information of the DVC. Consequently, when a DVC is manipulated by the user to cause a change in the displayed information, the VCE object data will change in a corresponding manner. The value contained in the VCE object data may undergo further manipulation as provided by class-specific methods of the VCE object 630. For example, class-specific methods may further change the value by executing a scaling function on the value or converting a numerical value to a textual value. As with visual reference objects 620, a user may load code comprising class-specific methods into a VCE object 630 using the VNOS engine 360 stored in the UI device 300.

As is the case with other objects, the VCE object data includes a list of references to related window, visual reference, VCE, device and packet objects and generic methods providing for communication between these objects. However, unlike the window object 610 and the visual reference object 620, the VCE object itself does not appear on the computer display 340. Hence, class-specific methods, which would normally control a VCE object's appearance, are not present.

In one of the embodiments of the VNOS system 200, the data and class-specific methods of VCE objects 630 can be used to define “master” and “slave” VCE objects, wherein a master VCE object can be used to control a slave VCE object. In this embodiment, VCE object data comprises a list of references to slave and master VCE objects, while the class-specific methods provide logic for manipulating slave and master VCE objects.

In a related embodiment of the VNOS system 200, the data and class-specific methods of VCE objects 630 can be used to define “aliased” VCE objects, wherein VCE object data comprises a list of references to aliased VCE objects, and vice versa, such that a change in one object results in an identical change in all aliased objects. The class specific methods provide the logic for manipulating aliased VCE objects.

A system element object 640 contains the methods and data for communicating with a particular type of system element 210, 220, or 230 and for managing a graphical control display, i.e., a graphical representation of that system element in a window. The data of a system element object 640 contains a database of related VCE objects 630 and list of references to the other system element objects in the same class. Some generic methods of a system element object 545 provide for data translation, while other generic methods of a device object provide for communication between the device object and other types of objects. Class-specific methods of a system element object 640 provide for special window, packet, and VCE object handling and for managing the graphical control display or graphical representation of a system element 210, 220, or 230 in a window.

A packet object 650 contains the methods and data for generically communicating between a system element 210, 220, or 230 and the UI device 300 via the VNOS network 100. In addition, the data of a packet object contains a list of references to related VCE objects 630 and system element objects 640. The data of a packet object includes system element information to be transmitted over the network in a data packet. Hence, packet object data contains the value(s) represented by one or more DVCs and stored in one or more VCEs. Class-specific methods of a packet object 650 provide for communication between the personal UI device 300 and system elements 210, 220, 230 via the VNOS network 100 over different ports or in conjunction with the MediaLink protocol, or other communication protocols.

By definition, an instance is a specific object with the behaviors defined by its class. An instance inherits all the methods of its class, but has particular data associated with it that is unique. Consequently, each instance inherits the generic and class-specific methods of its class. For example, a window instance 615 inherits the generic methods, and the class-specific methods of the related window object 610. Thus, a window instance includes generic methods, and class-specific methods, plus unique data. Likewise, the data and methods of the remaining instances include generic methods, class-specific methods and data. The window 615, visual reference 625, VCE 635, system element 645, and packet instances 655 can be instantiated from the object database 470 of the Vaemon device 400).

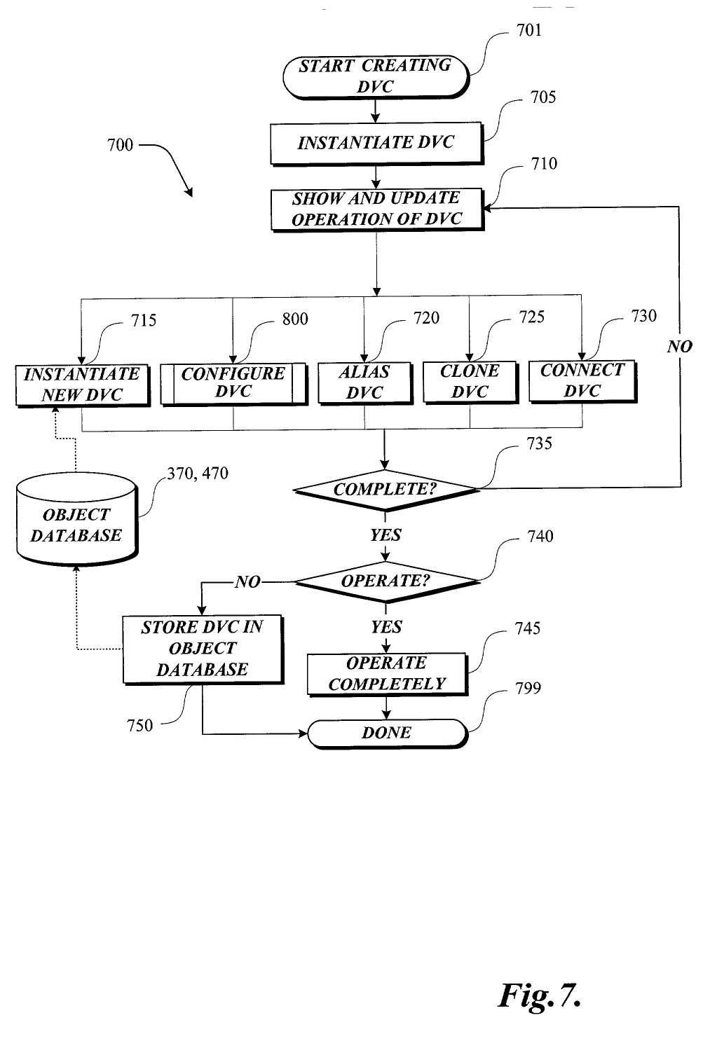

For illustration purposes a VU (“volume unit”) meter object 670 is illustrated in FIG. 6B. The VU meter object 670 contains both data 680 and methods 690. The methods contain generic methods such as get value and set value methods 692 and a draw method 698. The data contains generic data such as value 682. The VU meter object 670 also contains class specific methods and data. Among the class specific data are meter bar data 684 and meter bar color data 686. The class specific methods include methods related to getting and setting data relating to the size of a meter bar size and getting and setting the colors of the meter bar 696. Particular attention is directed to the generic draw method 698 as it relates to the show and update operation of DVC box 710 of FIG. 7. Using a draw method as a generic method makes it possible to routinely update the appearance of an object as changes are made to the object.

As described above, one embodiment of the graphical control system of the present invention includes a UI device 300, and system elements 210, 220, or 230, a VNOS network 100 for connecting the UI device 300 to the system elements based on the object-oriented programming paradigm just described. Embodiments of this graphical control system can best be understood by describing the embodiment of VNOS system 200 and the object-oriented programming paradigm in which it exists. Such a description follows.

Returning briefly to FIG. 5, it is the window, visual reference, VCE, system element, packet, and the DVC instances that carry out the functions depicted in blocks 510 through 560 and described above. The flow of messages between these instances within the object-oriented programming paradigm are more fully described next. For purposes of clarity in illustration, the references linking each instance have been omitted so that only the flow of messages between instances is shown in the accompanying figures. However, those of ordinary skill in the object-oriented programming art will recognize that the flow of messages follows the paths established by the references linking the instances. In addition, those of ordinary skill in this art will appreciate that the flow of messages is bi-directional, meaning messages may flow between instances in either direction. An exception exists for messages sent to and from packet instances since packet instances are either incoming from or outgoing to the VNOS network 100.

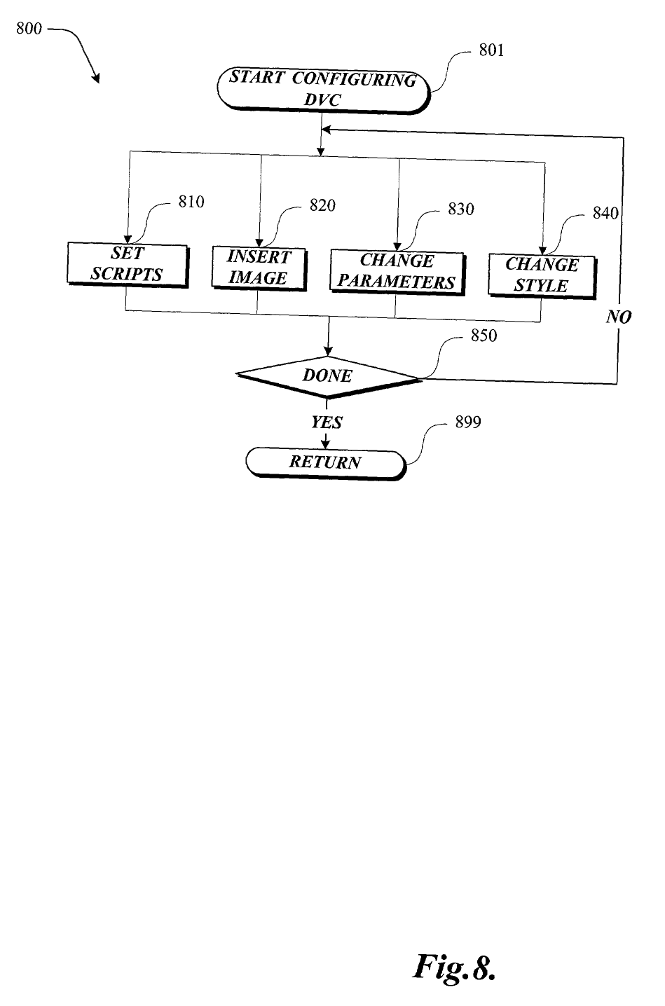

As illustrated in FIGS. 2 and 3, the VNOS system 200 of the present invention includes a UI device 300 that is used to present a graphical user interface when operating and developing decomposable visual components in accordance with the present invention. A flow chart illustrating the process of creating such a DVC on a UI device 300 in accordance with one embodiment of the present invention is shown as process 700 in FIG. 7. The DVC creation process begins in block 701 and proceeds to block 705, where a new DVC is instantiated. Either a blank DVC which is little more than a placeholder is instantiated or a previously defined DVC is retrieved from an object database 370, 470 which is then instantiated with all of its predefined values and routines. Next, in block 710, the DVC is shown on the user interface 365 of the UI device 300, with the DVC operating to the extent that it has operating functionality already defined. For example, if a VU meter DVC was instantiated but was not further defined, in one embodiment, the DVC would show a VU meter with a default level of zero and no bar would be shown in the meter. However, if the VU meter was then connected to some input source with varying values being sent to the default input VU meter, then the bar of the VU meter would vary with the value of that input source. Accordingly, once the DVC has been shown and is in operation in block 710 then the DVC may be incorporated or changed in that operating environment. However, a number of possible options are available to continue creating a DVC, such as instantiating a new DVC 715 configuring the current DVC 800 aliasing the DVC 720, cloning the DVC 725 or connecting the DVC to some other object 730. Although five different options have been illustrated here, those of ordinary skill in the art will appreciate that other options may be available. As just mentioned, the various options may include instantiating a new DVC as shown in block 715 after which, in decision block 735, a determination is made whether the creation of the DVC is complete and if it is determined that it is not complete, processing continues back to block 710 to show an update of the DVCs current status after the latest action. Further actions may include aliasing the DVC 720 as noted earlier, such that a new DVC is created that mirrors both the appearance and operation of the current DVC. This is particularly helpful when there are multiple windows or applications in which DVCs are supposed to be coordinated in real time. For example, using the VU meter example again, if multiple windows are supposed to indicate a current value in a VU meter, then the same VU meter can be aliased in each of the multiple windows. However, while the aliased DVC mirrors the operation and appearance of the original DVC, it is a separate instance and may have its properties configured separately while still maintaining the alias connection. For example, while one VU meter may be red the properties of a second VU meter can be changed to make it blue. This would then allow multiple windows to have separate “schemes” that represents a particular look and feel for that window while still maintaining the aliased operations for the VU meter. Configuring a DVC is shown in block 800 and is described in detail below with reference to FIG. 8.

Block 725 notes that it is possible to clone a DVC. Similar to aliasing a DVC cloning copies of the values and operations of an original DVC, however, the point at which the DVC is cloned is the break-off point of the relationship between the two DVCs. For example, if a fader DVC has an original value of 5, a cloned fader DVC would also start at a value of 5. However, moving the cloned fader would not affect the original fader nor vice versa. If you will, the cloned DVC is a snapshot of the original DVC at the point in which it was cloned, after which the values and relations to other DVCs may change. Another possible action is illustrated in block 730 which is to connect the DVC. Again, returning to the VU meter example, it is possible to directly connect the value of a fader to the VU meter. This simple connection just relates the bar of a VU meter to the position of a fader slider within a fader such that raising the slider on the fader raises the bar in the VU meter. A more complex example would be to connect a fader to a DVC representing a network server, in particular, connect the fader to the input value representing the number of allowed connections to the network server. Then connecting the network server DVC, in particular a value representing the number of current connections to the network server, to the VU meter. As a result of this connection, when the fader level increases because the number of current connections has increased, the VU meter's bar increases. The end result is a correlation between the fader DVC and the VU meter DVC. Each one of the possible actions 715, 800, 720, 727, 730 is repeated as needed in creating a new DVC until in determination block 735 it is determined that the DVC creation process is complete. Then, in determination block 740, a determination is made whether the DVC should continue operating at that point and if so the DVC operates in its complete form in block 745 and then the process ends at block 799.

However, if in determination block 740 a determination is made that the DVC should not be operated then in block 750 the DVC is stored in an object database such as object databases 370 of the UI device 300 or object database 470 of the Vaemon device 400. After the newly created DVC is stored in the object database 370, 470 the process 700 ends at block 799.

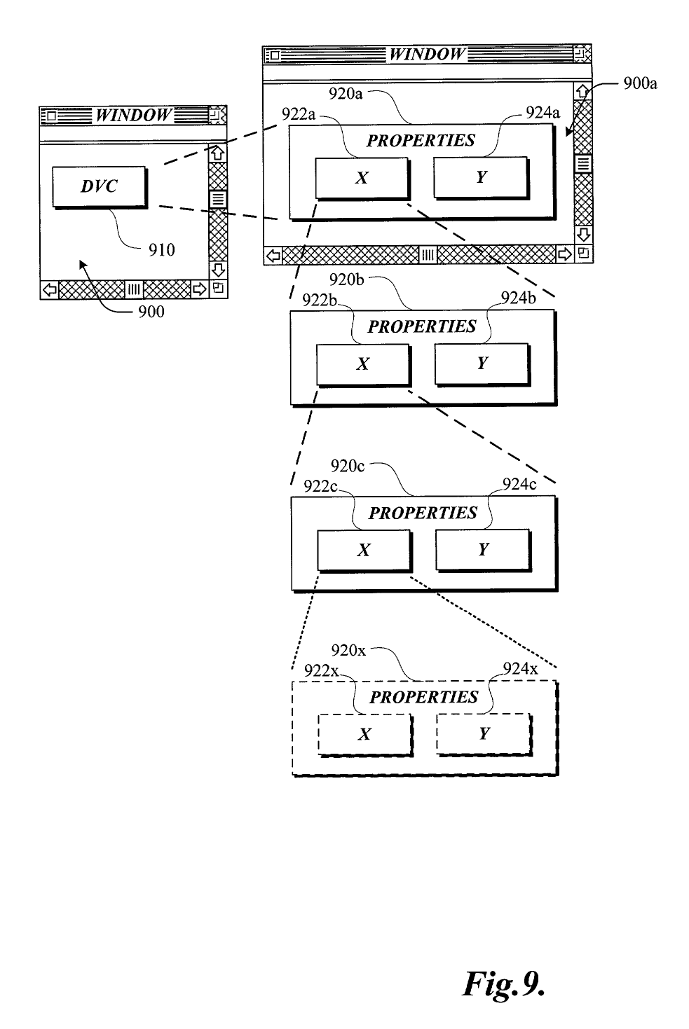

The DVC configuration subprocess 800, introduced above, is illustrated in FIG. 8. Subprocess 800 is performed each time a DVC needs to be further configured. Subprocess 800 starts in block 801 and then proceeds to either block 810, 820, 830, or 840. Taking each of these blocks in turn, in block 810 scripts are set to the DVC. Scripts include any type of processing or calculation scripts that may be used by the DVC to handle its values and/or functions. For example, a VU meter DVC that displays a solid green bar indicating the level of its received inputs but may include a script that changes the green bar to a red bar if a certain threshold level is reached. This is accomplished by setting a script in the configuration process of the DVC that observes the input value and then changes a color value in the properties or parameters of the DVC when the threshold level is reached. Another possible configuration action is inserting some type of multimedia file associated with the DVC. As shown in block 820 an image could be inserted into a DVC to alter its appearance. One simple example is a DVC representing a network server which when there are no connections is represented by one image and when there are connections is represented by another image. As shown in block 830 the parameters of a DVC can be changed. Parameters or properties of a DVC generally affect all aspects of the appearance of the DVC as well as other values stored by the DVC. For example, the position of a DVC within a window is determined, for example, by X and Y coordinates in the properties of the DVC. For example, as shown in FIG. 9 a DVC 910 has associated properties 920a that include X and Y coordinate values 922a and 924a respectively. Therefore, if in block 830 the X value 922a and the Y value at 924a are changed the position of the DVC 910 changes within the window 900.

This action is described in more detail below.

Another possible configuration action is changing the style of the DVC as shown in block 840. This allows the class of a DVC to be changed during the operation of the DVC and its associated connections. For example, if a VU meter showing the number of connections to the network server is changed to a fader the fader would to the best of its ability take the place of the VU meter. As both the VU meter and the fader essentially track a single value the fader's behavior would mimic that of a VU meter in the sense that as the number of connections on the network server would change the slider on the fader. Those of ordinary skill in the art will appreciate that this ability to change style (class) during the operation of the DVC is a particularly powerful tool to allow for rapid prototyping and testing of applications using DVCs. After each action of blocks 810-840 is finished, subprocess 800 proceeds to decision block 850 in which a determination is made whether configuration of the DVC is done, and if it is not done, the processing returns to allow for continued configuration. If, however, in decision block 850 it is determined that all configuration is done, then processing continues to block 899 which returns to the calling routine.

As mentioned above, each DVC has associated properties FIG. 9 illustrates the recursive nature of the properties used. The example DVC 910 shown in FIG. 9 placed in window 900, has properties 920a associated with it which are shown as residing in a separate window 900a. However, each of the components 922a, 924a are themselves DVCs which in turn have their own properties. Accordingly, the X value stored in the X value DVC 922a in turn has X and Y property values 922b and 924b stored in its properties 920b. In turn, the X value DVC 922b has X and Y property values 922c and 924c. This continues recursively such that for every DVC there is a set of properties represented as 920x having X and Y coordinate values 922x, 924x. The foregoing description and FIG. 9 show that while DVCs may be built out of other DVCs, DVCs also inherently can be decomposed into still further DVCs that may not have explicitly been incorporated in the creation process, (FIG. 7) but are inherent in DVCs used by the VNOS system 200.

A system having separate decomposing property and property component DVCs has the ability to configure the properties of a DVC to respond to predetermined situations. For example, if the threshold of a VU meter exceeds a certain point, its coordinate values may be adjusted to move the VU meter into a position of greater prominence on the window in which it resides. Those of ordinary skill in the art will appreciate other significant benefits to being able to manipulate the properties of a DVC as DVCs themselves when creating and/or operating DVCs.

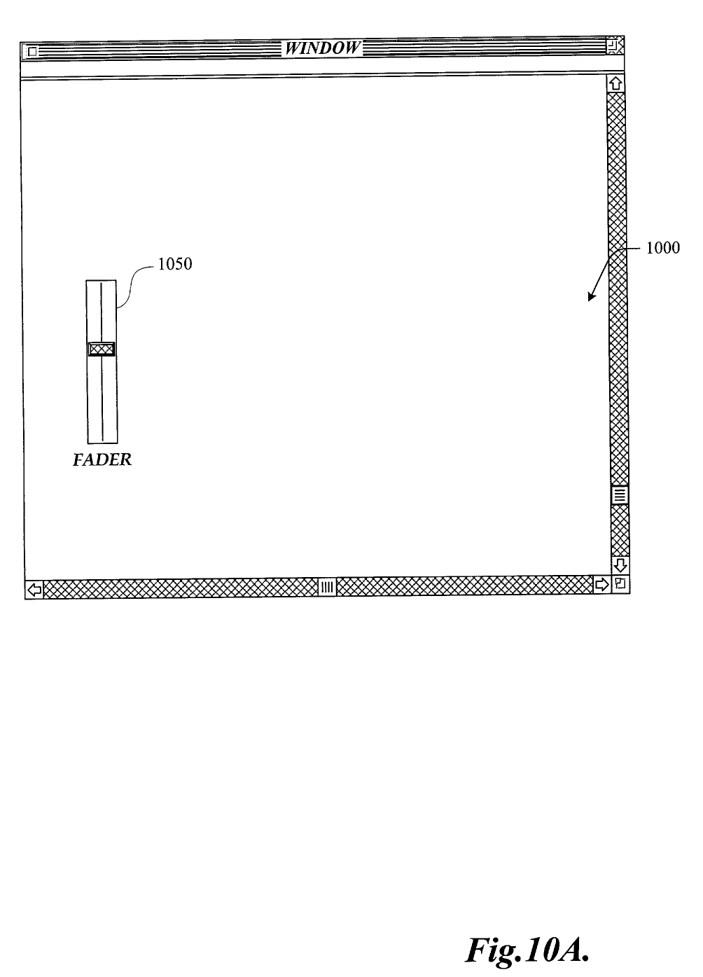

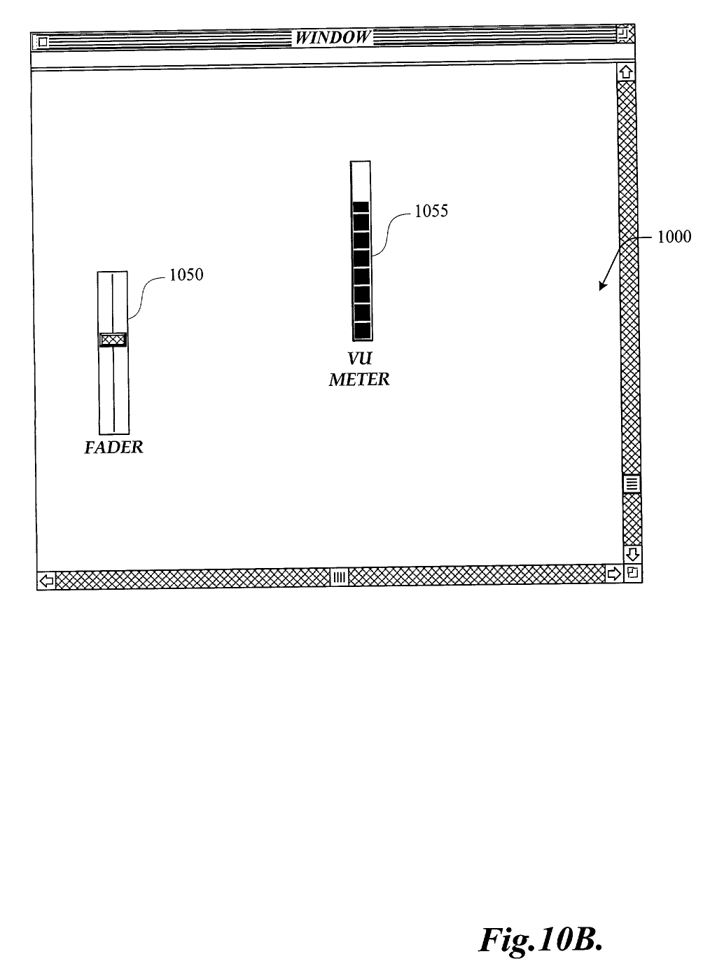

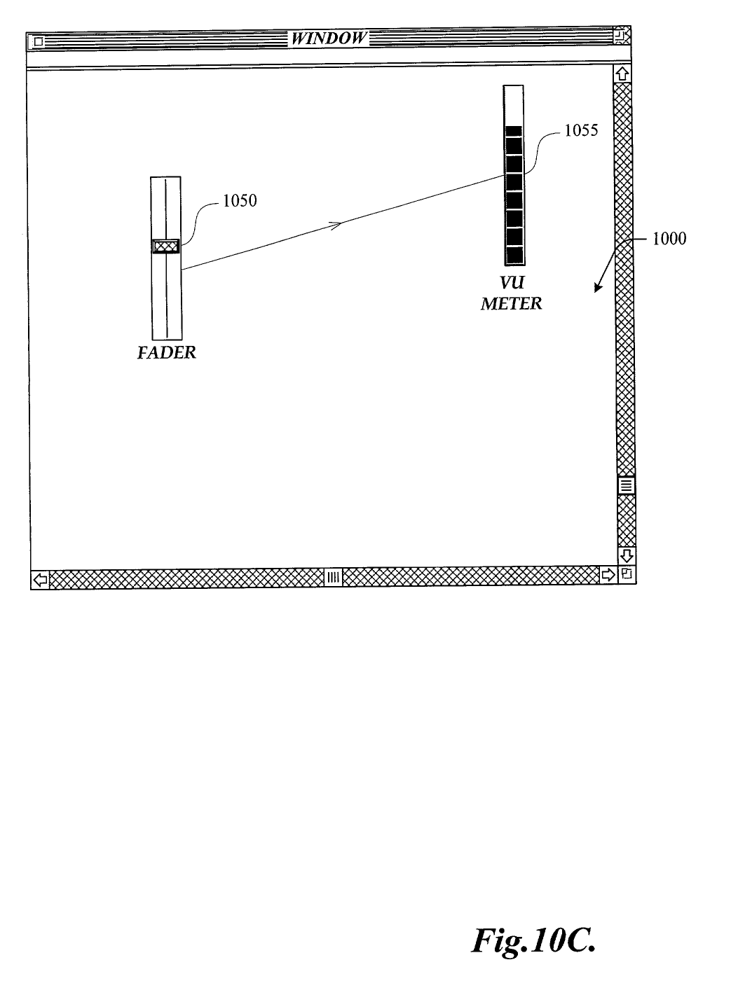

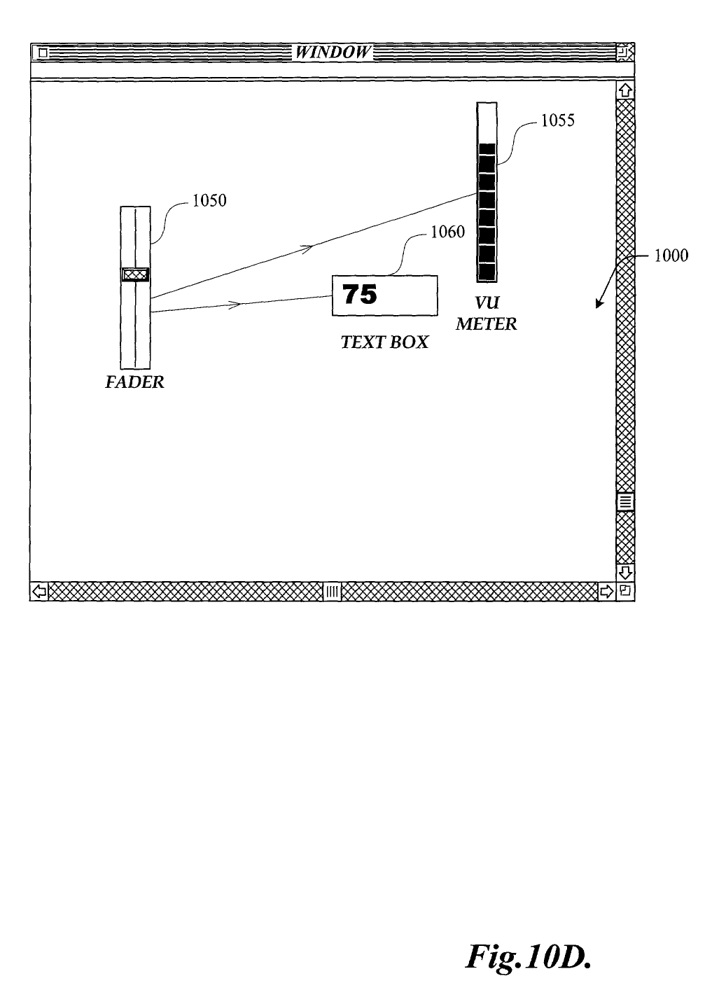

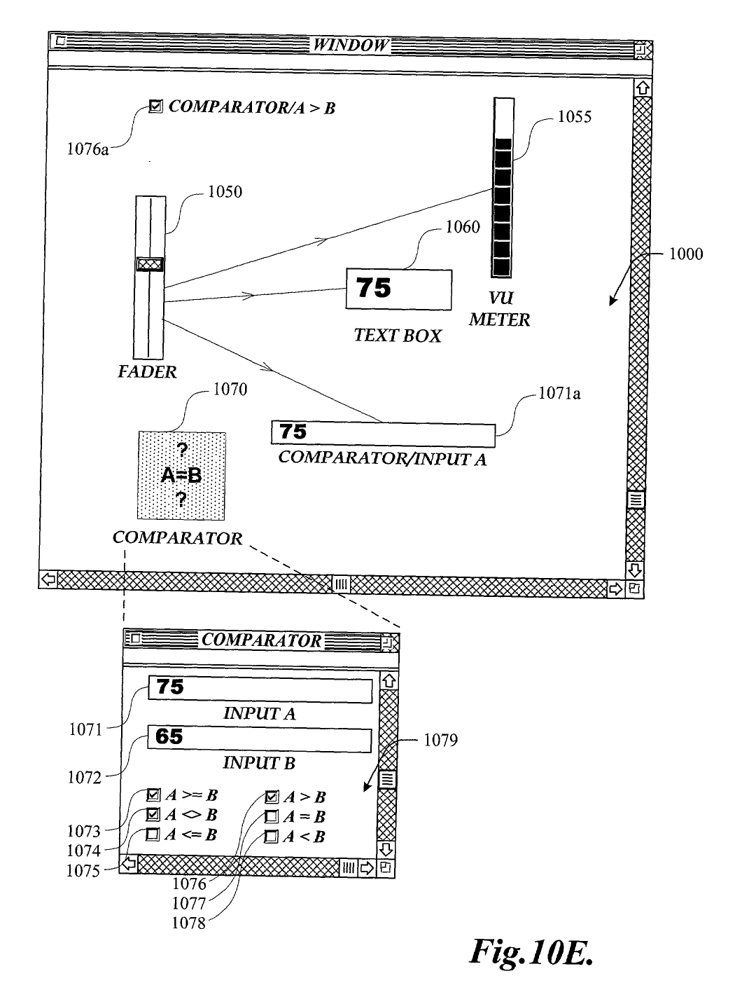

FIGS. 10A-10E represent a series of exemplary windows illustrating the user interface during the DVC creation process. FIG. 10A shows a window 1000 with an instance of a fader 1050. FIG. 10B shows a VU meter 1066 added to the window 1000 . Neither the fader nor the VU meter are connected to themselves or to any other devices. Thus, both the fades and the VU meter remain at a default level at which they were instantiated.

FIG. 10C shows the fader 1050 connected to the VU meter 1055. Note the connection is a directional connection so that the variance in the fader 1050 directly affects the bar of the VU meter 1055.

FIG. 10D shows a text box 1060 added to the window 1000 which also holds the fader 1050 connected to the VU meter 1055. The text box 1060 contains a numerical value and is connected to the fader 1050. As a result, when the fader is adjusted the numerical value in the text box 1060 changes accordingly.

FIG. 10E is more complex. Again, the window 1000 includes the fader 1050 connected to the VU meter 1055 and the text box 1060. The window 1000 also includes a DVC 1070. In addition to residing in window 1020 the comparator 1070 has its own window 1079 containing various visual elements including an input A element 1071. The input A element 1071 is shown as aliased as a comparator/input A element 1071a in window 1020. Window 1020 also shows that comparator/input A element 1071a is connected to the fader such that the fader affects the input value in a similar manner to the way the fader affects the value shown in text box 1060. However, unlike text box 1060, the comparator/input A component 1071a is aliased to the input A component 1071 of comparator 1070. Accordingly, as the value of the comparator/input A component 1071a is changed the change is reflected in the input A component 1071a of comparator 1070. The comparator 1070 is a simple DVC for comparing two values designated input A and input B, and adjusting a series of six components to reflect the results of the comparison. For example, if input A 1071 has a value of 75 and input B 1072 has a value of 65 the various comparison calculation components are set as follows: (i) an A is greater than the equal to B check box 1073 is checked; (ii) an A is either greater or less than B check box 1074 is checked; (iii) an A is less than or equal to B check box 1075 is not checked; (iv) an A is greater than B check box 1076 is checked; (v) for A is equal to B check box 1077 is not checked; and (vi) an A is less than B check box 1078 is not checked. Note however that in this example show check box 1076 has been aliased into window 1020 where this check box is shown as a comparator/A is greater than B check box 1076a which is checked. When reviewing the operating DVC illustrated in FIG. 10E and described above, it will then be apparent that as fader 1050 is adjusted downward by a value of 10, for example, the VU meter 1050 will decrease the level in its bar the text box 1060 will reflect a value of 65, the aliased comparator/input A 1071a will reflect a value of 65 and different check boxes 1073-1078 will be checked and unchecked.

While a simple DVC has been composed for illustrative purposes in FIGS. 10A-10E, those of ordinary skill in the art will appreciate that much more complex DVCs may be composed with relative ease using this invention.

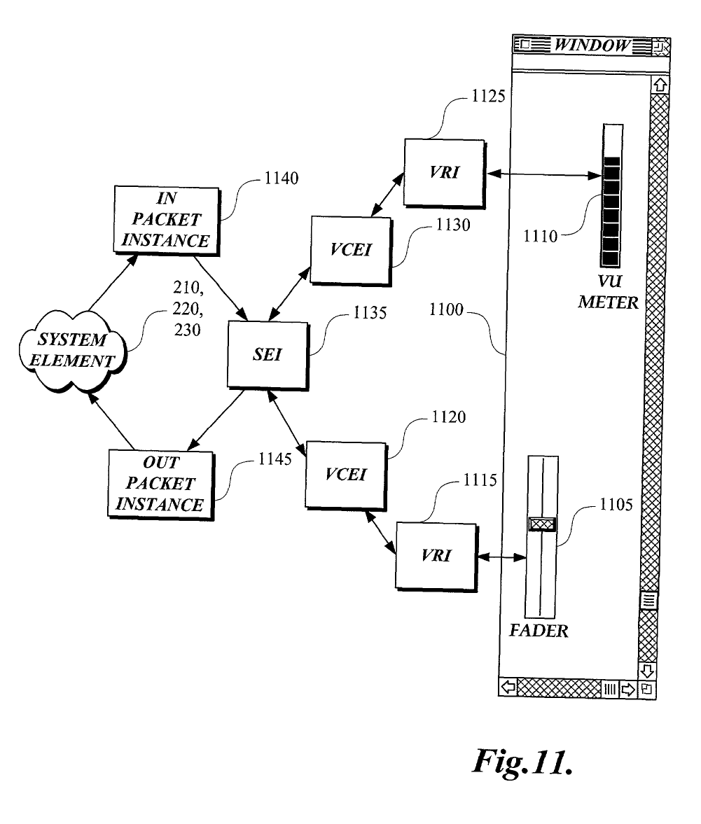

FIG. 11 illustrates how a graphical control system formed in accordance with the invention enables a user to control a system element 210, 220, 230 via a graphical representation. The UI 365 (FIG. 3) generates a window instance 615 (FIG. 6A) on the display 340 (FIG. 3). For illustration purposes, only a VU meter DVC 1110 and a fader DVC 1105 are shown in the window of the display shown in FIG. 11. The user can graphically manipulate any of the DVCs by using the UI 365 and any conventional manipulation device (mouse, keyboard, joystick, stylus, etc.).

When the user manipulates the fader DVC 1105, the user causes a variation in or changes the value represented by the setting of the fader DVC 1105. As a result, the fader 1105 sends a message to a related visual reference instance 1115 notifying it of the change in value. The visual reference instance 1115 responds in two ways. First, the generic methods of the visual reference instance 1115 regenerate the fader DVC 1105 so that it corresponds graphically to the change in value. To the user, this regeneration appears instantaneously. Second, the visual reference instance 1115 sends a message to a VCE instance 1120 associated with fader DVC 1105 notifying it of the change in value. The VCE instance 1120 stores the change in value caused by the user manipulation and sends a message to a system element instance 1135 that represents some system element 210, 220, 230 which may have multiple values, at least one of which is affected by the fader DVC 1105 and one of which is observed by the VU meter.

The class-specific methods of the VCE instance 1120 associated with the first fader DVC 1105 may further manipulate and change the value before sending a message to the system element instance 1135. For example, the user may desire to increase the fader level to 20. In order to accomplish this, the user uses a mouse to adjust the movable element of the fader DVC 1105 to a “20” level. If the class-specific methods were predefined to set the maximum allowable decibel level at “15,” the adjustment level (20) could not be achieved. In this example, the class-specific methods would change the value to be stored in the VCE instance 1120 from 20 to 15. The VCE instance 1120 would then send a message to both the visual reference instance 1115 and the system element instance 1135 notifying them of this change in value. Consequently, visual reference instance 1115 would regenerate the fader DVC 1105 so that its movable element would correspond to 15.

Once notified of the change in value, class-specific methods of the system element instance 1135 prepares an outgoing packet instance 1145 containing the new value data. The outgoing packet instance 1145 is then transformed into a conventional packet by the platform operating services of the VNOS engine 360 and sent over the VNOS network 100 to notify the system element 210, 220, 230 of the change in value. Upon receipt, the system element correspondingly adjusts the level controlled by DVC fader 1105.

It should be understood that when a control of a system element 210, 220, or 230 is changed (e.g., by manual operation or monitored electrical change), the flow of messages depicted in FIG. 11 is reversed and that when the DVCs 40 graphically representing those controls on screen 34 are regenerated they are regenerated in a way that shows the change. For example, if the level of the system element 210, 220, 230 is increased by manually adjusting the fader DVC 1105 associated with an actual system element, the SEI 1135 receives an in packet instance 1140 containing the change in value via the VNOS network 100. Alternately, the SEI 1135 is adapted to directly observe the actual system element 210, 220, 230 to detect such changes in value. The VNOS engine 360 of the personal UI device 300 transforms the packet/change into an incoming packet instance 1140. The incoming packet instance 1140 sends a message to system element instance 1135 of the system element 210, 220, 230 that notifies the system element instance of the change in value made by the system element or manual adjustment of the fader DVC 1150. The generic methods of the system element instance 1135 then send a message to the VCE instance 1120 associated with the fader DVC 1105. The change in value is then stored in the VCE instance 1120. The VCE instance 1120 then sends a message to the visual reference instance 1115 notifying it of the change in value. The methods of visual reference instance 1115 cause the fader DVC 1105 to be regenerated in a manner that corresponds to the change in value effectuated by system element or manually adjusting the fader.

It must also be appreciated that as an observed value (e.g., a number of users, or decibel levels) of a system element 210, 220, or 230 fluctuates or changes, the flow of messages depicted in FIG. 11 is reversed and the DVCs 1105 and 1110 graphically representing those values on the window 1500 are regenerated accordingly. For example, as a value observed by VU meter 1110 fluctuates, the system element 210, 220, 230 repeatedly sends packets to the personal UI device 300 via the VNOS network 100. Each packet contains the change in value associated with the VU meter 1110 at a particular instant. The VNOS engine 360 stored in the UI device 360 constantly polls the VNOS network 100 for incoming packets. Thus, the VNOS engine 360 transforms received packets in rapid succession. For each packet transformed into an incoming packet instance by the VNOS engine 360, virtually the same sequence of events as described above occurs, except that the flow of messages between instances is relatively constant. More specifically, for each incoming packet instance 1140, the system element instance 1135 sends a message to a VCE instance 1120 associated with the VU meter DVC 1110. The VCE instance 1130 stores the change in value associated with the VU meter 1110 and sends a message to a visual reference instance 1125. Consequently, visual reference instance 1125 regenerates the VU meter DVC 1110. However, the visual reference instance 1125 is constantly receiving a message notifying it of a change in value because the values being received from the system element 210, 220, 230 may be constantly fluctuating. Therefore, the visual reference instance 1125 is constantly regenerating the VU meter DVC 1110 so that the VU meter DVC 1110 graphically depicts the changes to the observed value from the system element 210, 220, 230.

While the preferred embodiment of the invention has been illustrated and described, it will be appreciated that various changes can be made therein without departing from the spirit and scope of the invention. Thus, it is to be understood that within the scope of the appended claims the invention can be practiced otherwise than as specifically described herein.

The embodiments of the invention in which an exclusive property or privilege is claimed are defined as follows:

1. A method of creating a decomposable visual component in a visual networking operating system, the method comprising:
providing a library of visual component templates;
instantiating the decomposable visual component from said library; and
configuring the decomposable visual component while said decomposable visual component is operating.

2. The method of claim 1, wherein configuring said decomposable visual component comprises setting a script to affect the behavior of the decomposable visual component.

3. The method of claim 1, wherein configuring said decomposable visual component comprises adding an image to said visual component.

4. The method of claim 1, wherein configuring said decomposable visual component comprises changing at least one parameter of the decomposable visual component.

5. The method of claim 1, wherein configuring said decomposable visual component comprises changing a style of decomposable visual component.

6. The method of claim 1, further comprising creating an alias of the decomposable visual component.

7. The method of claim 1 further comprising creating a clone of the decomposable visual component.

8. The method of claim 1, wherein multiple decomposable visual components are instantiated and configured to form a complex decomposable visual component.

9. The method of claim 1, wherein the decomposable visual component is recursively decomposable.

10. The method of claim 1, further comprising connecting the decomposable visual component with a second decomposable visual component while said second decomposable visual component is operating.

11. The method of claim 10, wherein a change in a value of the decomposable visual component is reflected in a value of the second decomposable visual component.

12. The method of claim 11, wherein a change in a third decomposable visual component associated with said first value is reflected in a fourth decomposable visual component associated with said second value.

13. The method of claim 12, wherein the decomposable visual component comprises a plurality of decomposable visual components, including said third decomposable visual component.

14. The method of claim 12, wherein the decomposable visual component comprises a plurality of decomposable visual component; and said third decomposable visual component is an alias of one of said plurality of decomposable visual components.

15. The method of claim 10, wherein said second decomposable visual component represents a non-visual component.

16. The method of claim 15, wherein said non-visual component is a non-computing device.

17. The method of claim 15, wherein said non-visual component is a computing device.

18. The method of claim 15, wherein said non-visual component comprises computer executed instructions.

19. The method of claim 18, wherein said non-visual component interfaces with said second decomposable visual component though the standard in and standard out access prints.

20. A method for controlling a target decomposable visual component within a visual networking operating system, the method comprising:
depicting a control decomposable visual component;
enabling a user to modify said control decomposable visual component so as to generate a change in a first value;
communicating the change in said first value to the target decomposable visual component;
the target decomposable visual component detecting the change in said first value and effectuating a change in a second value; and
said change in said second value effectuating a change in the target decomposable visual component.

21. The method of claim 20, wherein said target decomposable visual component is associated with a target device.

22. The method of claim 21, wherein said target device is coupled with said target decomposable visual component so that a change in one effectuates a change in the other.

23. The method of claim 22, wherein said target device is a non-competing device.

24. The method of claim 22, wherein said target device is a non-computing device.

25. The method of claim 22, wherein said target device is an application executing on a computing device.

26. The method of claim 22, further comprising connecting said control decomposable visual component with a second decomposable visual component to form a combined decomposable visual component.

27. The method of claim 20, wherein said control decomposable visual component comprises multiple constituent decomposable visual components.

28. The method of claim 27, further comprising decomposing said control decomposable visual component; selecting a first constituent decomposable visual component; and configuring said first constituent decomposable visual component.

29. The method of claim 28, wherein configuring said first constituent decomposable visual component comprises setting a script to affect the behavior of said first constituent decomposable visual component.

30. The method of claim 28, wherein configuring said first constituent decomposable visual component comprises changing at least one parameter of said first constituent decomposable visual component.

31. The method of claim 28, wherein configuring said first constituent decomposable visual component comprises changing a style of said first constituent decomposable visual component.

32. The method of claim 28, connecting said first constituent decomposable visual component to a third decomposable visual component.

33. The method of claim 25, wherein the target decomposable visual component communicates with said application via a standard in and a standard out interface.

34. The method of claim 20, wherein said control decomposable visual component and the target decomposable visual component are on separate computing devices.

35. The method of claim 34 wherein communicating further comprises sending packet information between said control decomposable visual component and the target decomposable visual component.

36. The method of claim 35, wherein communicating further comprises communicating over an internetwork.

37. A computer readable medium containing computer executable instructions for performing any of the methods at claims 1-19.

38. A computer readable medium containing computer executable instructions for performing any of the methods at claims 20-36.

39. A computer apparatus, within a computing network, the apparatus operative to execute instructions for performing any of the methods of claims 1-19.

40. A computer apparatus, within a computing network, the apparatus operative to execute instructions for performing any of the methods of claims 20-36.
